(19) United States
(12) Patent Application Publication
(10) Pub. No.: US 2023/0419097 A1
(43) Pub. Date: Dec. 28, 2023

(54) UNDERSTANDING REINFORCEMENT LEARNING POLICIES BY IDENTIFYING STRATEGIC STATES

(71) Applicant: International Business Machines Corporation, Armonk, NY (US)

(72) Inventors: Ronny Luss, Yorktown Heights, NY (US); Amit Dhurandhar, Yorktown Heights, NY (US); MIAO LIU, Ossining, NY (US)

(21) Appl. No.: 17/808,181

(22) Filed: Jun. 22, 2022

(51) Int. Cl. G06N 3/08

(52) U.S. Cl. CPC G06N 3/08

(57) ABSTRACT

One or more computer processors compute a maximum likelihood path matrix comprising a respective shortest path between each state in a set of states associated with a model trained with a deep reinforcement learning policy. The one or more computer processors generate explanations for the deep reinforcement learning policy based one or more identified meta-states for each state in the set of states and corresponding selected strategic states utilizing the computed maximum likelihood path matrix.

### STATEMENT REGARDING PRIOR DISCLOSURES BY THE INVENTOR OR A JOINT INVENTOR

The following disclosure(s) are submitted under 35 U.S.C. 102(b)(1)(A):

(i) Local Explanations for Reinforcement Learning; Ronny Luss, Amit Dhurandhar, and Miao Liu; and Feb. 8, 2022, made publicly available.

### BACKGROUND

The present invention relates generally to the field of machine learning, and more particularly to reinforcement learning.

Explainable AI (XAI), or Interpretable AI, or Explainable Machine Learning (XML), is artificial intelligence (AI) in which humans can understand the results of the solution. It contrasts with the concept of the “black box” in machine learning where even its designers cannot explain why an AI arrived at a specific decision. By refining the mental models of users of AI-powered systems and dismantling their misconceptions, XAI promises to help users perform more effectively. For example, XAI can improve the user experience of a product or service by helping end users trust that the AI is making good decisions. This way the aim of XAI is to explain what has been done, what is done right now, what will be done next and unveil the information the actions are based on. These characteristics make it possible (i) to confirm existing knowledge (ii) to challenge existing knowledge and (iii) to generate new assumptions.

### SUMMARY

Embodiments of the present invention disclose a computer-implemented method, a computer program product, and a system. The computer-implemented method includes one or more computer processers computing a maximum likelihood path matrix comprising a respective shortest path between each state in a set of states associated with a model trained with a deep reinforcement learning policy. The one or more computer processors generate explanations for the deep reinforcement learning policy based one or more identified meta-states for each state in the set of states and corresponding selected strategic states utilizing the computed maximum likelihood path matrix.

### BRIEF DESCRIPTION OF THE DRAWINGS

FIG. (i.e., FIG. 1 is a functional block diagram illustrating a computational environment, in accordance with an embodiment of the present invention;

FIG. 2 is a flowchart depicting operational steps of a program, on a server computer within the computational environment of FIG. 1, for Strategic State eXplanation (SSX), in accordance with an embodiment of the present invention;

FIGS. 3A, 3B, and 3C illustrate an example of the program within the computational environment of FIG. 1, in accordance with an embodiment of the present invention;

FIG. 4 depicts an algorithm, in accordance with an illustrative embodiment of the present invention;

FIG. 5 depicts an algorithm, in accordance with an illustrative embodiment of the present invention;

FIG. 6 depicts an algorithm, in accordance with an illustrative embodiment of the present invention;

FIG. 7 depicts a chart, in accordance with an illustrative embodiment of the present invention;

FIG. 8 depicts a door-key explanation, in accordance with an illustrative embodiment of the present invention;

FIG. 9 depicts a maze game explanation, in accordance with an illustrative embodiment of the present invention;

FIGS. 10A and 10B depict charts, in accordance with an illustrative embodiment of the present invention; and

FIG. 11 is a block diagram of components of the server computer, in accordance with an embodiment of the present invention.

### DETAILED DESCRIPTION

Deep reinforcement learning has seen stupendous success over the last decade with superhuman performance in games such as Go and Chess. With increasing superior capabilities of automated (learning) systems, there is a strong push to understand the reasoning behind their decision making. One motivation is for users and related systems to improve performance in related activities (e.g., physical or virtual tasks). An even deeper reason is for users to trust these systems when deployed in real life scenarios. Safety, for instance, is of paramount importance in applications such as self-driving cars or deployments on unmanned aerial vehicles (UAVs). Regulations have passed in many countries that require that explanations be provided for automated decisions (e.g., handle personal identifiable information associated with one or more individuals). While various methods have been provided to explain classification modes and evaluated in application-grounded manners, the exploration of different perspectives to explain reinforcement learning (RL) policies has been limited.

A large body of work in explainable AI (XAI) has focused on explaining black-box classification models. Explaining deep reinforcement learning (RL) policies in a manner that could be understood by users and machine learning systems has received much less attention.

Embodiments of the present invention propose a novel method improve the accuracy and development of RL policies through identifying strategic states from learned meta-states of a RL trained model or network. The key conceptual difference between the present invention and many previous ones is that the present invention forms meta-states based on locality governed by the expert policy dynamics rather than based on similarity of actions, and that embodiments of the present invention do not assume any particular knowledge of the underlying topology of the state space. Theoretically, embodiments of the present invention show that meta-states converge and the objective to find strategic states for each meta-state is submodular leading to efficient high quality greedy selection. Experiments on three domains (four rooms, door-key, and maze game) illustrate that the present invention leads to better understanding of utilized RL policies. Embodiments of the present invention demonstrate that grouping of states to form meta-states being more intuitive in that corresponding strategic states are strong indicators of tractable intermediate goals, which can be utilized to provide presentable versions of actions and decisions taken by a RL model or network.

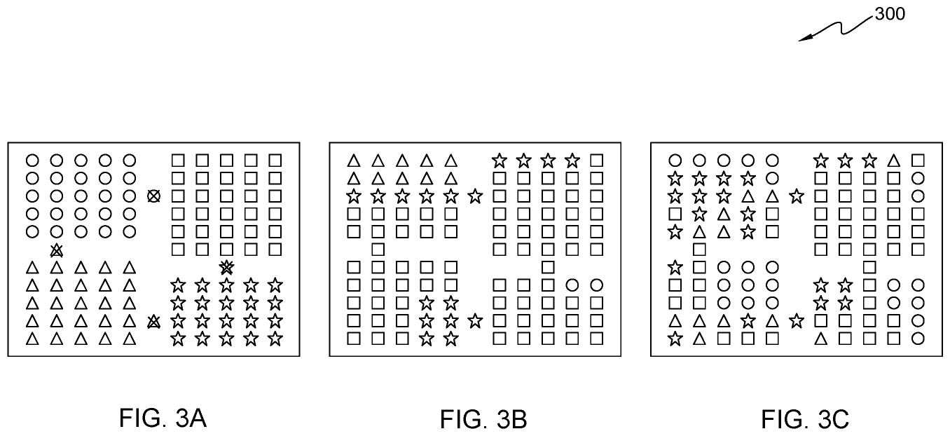

Embodiments of the present invention involve abstracting out meta-states based on the dynamics of the policy to be explained followed by identifying strategic states which act as intermediate goals for states belonging to a particular meta-state. These strategic states are essentially bottlenecks in the policy that the present invention identifies without assuming access to the underlying topology. An example of this is seen in FIG. 3A, where (roughly) each room is identified as a meta-state by the present invention with the corresponding doors (bottleneck states) being the strategic states for the meta-state. A key conceptual difference between the present invention compared to other global (and even local) explainable RL approaches is that other approaches aggregate insight (i.e., reduce dimension) as a function of actions, whereas embodiments of the present invention aggregate based on locality of the states determined by the expert policy dynamics and further identify strategic states based on these dynamics, where locality is not assuming knowledge of the underlying structure or topology of the state space. Embodiments of the present invention show that this perspective leads to more understandable RL policy explanations; aggregating based on actions, while precise, are too granular a view where the popular idiom cannot see the forest for the trees comes to mind. Embodiments of the present invention conjecture that the improved policy explanation and generation accuracy is due to grouping of states being more intuitive with strategic states indicating tractable intermediate goals that contain information regarding model decisions based on a RL policy. An example is illustrated in FIGS. 3B and 3C, where grouping based on actions for interpretability or for efficiency leads to less intuitive results.

Embodiments of the present invention offer a novel framework for understanding and improving RL policies and subsequently trained models, differing greatly from other methods in this space which create explanations based on similarity of actions rather than policy dynamics. Implementation of embodiments of the invention may take a variety of forms, and exemplary implementation details are discussed subsequently with reference to the Figures.

The present invention will now be described in detail with reference to the Figures.

FIG. 1 is a functional block diagram illustrating a computational environment, generally designated 100, in accordance with one embodiment of the present invention. The term “computational” as used in this specification describes a computer system that includes multiple, physically, distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computational environment 100 includes server computer 120 connected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between server computer 120, and other computing devices (not shown) within computational environment 100. In various embodiments, network 102 operates locally via wired, wireless, or optical connections and can be any combination of connections and protocols (e.g., personal area network (PAN), near field communication (NFC), laser, infrared, ultrasonic, etc.).

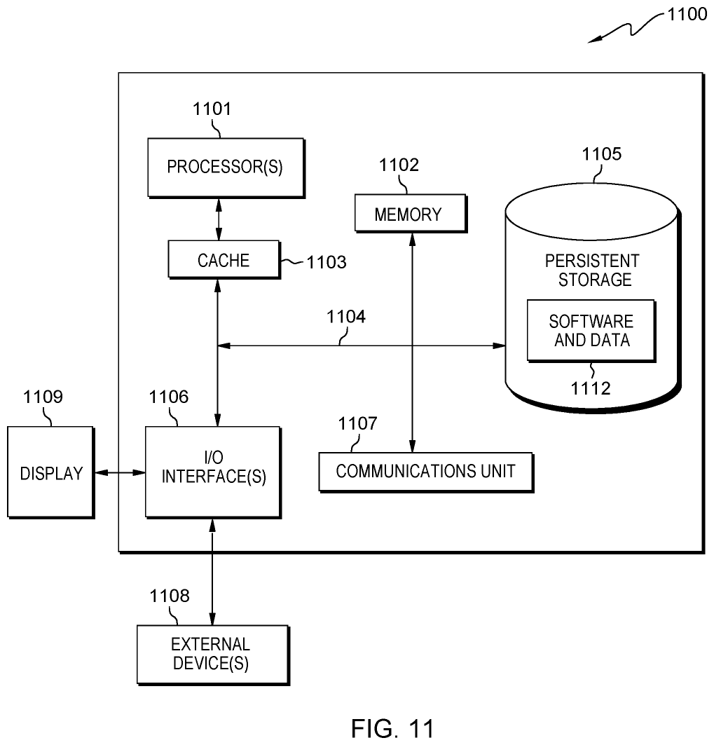

Server computer 120 can be a standalone computing device, a management server, a web server, a mobile computing device, or any other electronic device or computing system capable of receiving, sending, and processing data. In other embodiments, server computer 120 can represent a server computing system utilizing multiple computers as a server system, such as in a cloud computing environment. In another embodiment, server computer 120 can be a laptop computer, a tablet computer, a netbook computer, a personal computer (PC), a desktop computer, a personal digital assistant (PDA), a smart phone, or any programmable electronic device capable of communicating with other computing devices (not shown) within computational environment 100 via network 102. In another embodiment, server computer 120 represents a computing system utilizing clustered computers and components (e.g., database server computers, application server computers, etc.) that act as a single pool of seamless resources when accessed within computational environment 100. In the depicted embodiment, server computer 120 includes program 150. In other embodiments, server computer 120 may contain other applications, databases, programs, etc. which have not been depicted in computational environment 100. Server computer 120 may include internal and external hardware components, as depicted, and described in further detail with respect to FIG. 11.

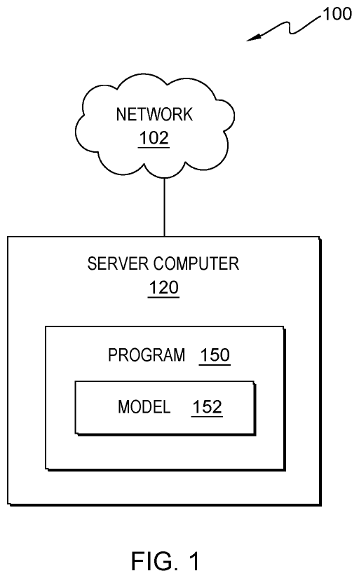

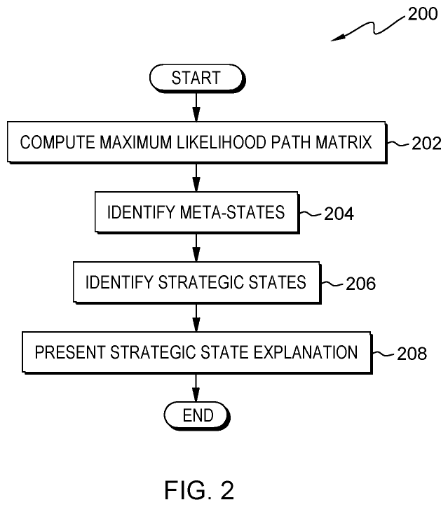

Program 150 is a program for Strategic State eXplanation (SSX) (i.e., explaining a decision made by a deep reinforcement learning policy). In various embodiments, program 150 may implement the following steps: compute a maximum likelihood path matrix comprising a respective shortest path between each state in a set of states associated with a model trained with a deep reinforcement learning policy and generate explanations for the deep reinforcement learning policy based one or more identified meta-states for each state in the set of states and corresponding selected strategic states utilizing the computed maximum likelihood path matrix. In the depicted embodiment, program 150 is a standalone software program. In another embodiment, the functionality of program 150, or any combination programs thereof, may be integrated into a single software program. In some embodiments, program 150 may be located on separate computing devices (not depicted) but can still communicate over network 102. In various embodiments, client versions of program 150 resides on any other computing device (not depicted) within computational environment 100. In the depicted embodiment, program 150 includes model 152. Program 150 is depicted and described in further detail with respect to FIG. 2.

Model 152 is representative of a model utilizing deep reinforcement learning techniques to train, calculate weights, ingest inputs, and output a plurality of solution vectors. In an embodiment, model 152 utilizes transferrable neural networks algorithms and models (e.g., long short-term memory (LSTM), deep stacking network (DSN), deep belief network (DBN), convolutional neural networks (CNN), compound hierarchical deep models, etc.) that can be trained with supervised deep reinforcement learning methods. In the depicted embodiment, model 152 has a plurality of domains, each representing different reinforcement learning (RL) regimes, including but not limit to: non-adversarial RL with a small state space and tabular representation for the policy, non-adversarial RL with a large state space and a deep neural network for the policy, and adversarial RL with a large state space and a deep neural network for the policy.

Embodiments of the present invention use the following notations. Let S define the full state space and s∈S be a state in the full state space. Denote the expert policy by π_{E}(⋅,⋅):(A,S)→ [symbol] where A is the action space. The notation π_{E}∈ [symbol] ^{|A|×|S|} is a matrix where each column is a distribution of actions to take given a state (i.e., the policy is stochastic). Note that embodiments of the present invention assume a transition function f_{E}(⋅,⋅):(S,S)→ [symbol] that defines the likelihood of going from one state to another state in one jump by following the expert policy. Let S₉₉={Φ₁, . . . , Φₖ} denote a meta-state space of cardinality k and ϕ(⋅):S→S_{ϕ} denote a meta-state mapping such that ϕ(s)∈S_{ϕ} is the meta-state assigned to s∈S. Denote m strategic states of meta-state Φ by G^{Φ}={g₁^{Φ}, . . . , gₘ^{Φ}} where g₁^{Φ∈S∀∈{}1, . . . , m}.

FIG. 2 depicts flowchart 200 illustrating operational steps of program 150 for Strategic State eXplanation (SSX), in accordance with an embodiment of the present invention.

Program 150 computes a maximum likelihood path matrix (step 202). In an embodiment, program 150 initiates responsive to an inputted model, a set of states, or an inputted task for a model. In an embodiment, program 150 computes a maximum likelihood path matrix comprising a plurality of shortest paths between states, wherein program 150 utilizes a criterion in which two states in the same meta-state should not be far away from each other (e.g., threshold distance, etc.). In an embodiment, program 150 computes a distance as a most likely path from state s to state s′ under π_{E}. In an embodiment, program 150 computes a fully connected, directed (in both directions) graph where the states are vertices and an edge from s to s′ has weight −log f_{E}(s,s′). In this embodiment, the shortest path is also the maximum likelihood path from s to s′. In a further embodiment, program 150 denotes by γ(s s′) the value of this maximum likelihood path and Γ∈ [symbol] ^{|S|×|S|} a matrix containing the values of these paths for all pairs of states in the state space. Γ, along with a predecessor matrix P can be used to derive the shortest paths, e.g., computed using Dijkstra's shortest path algorithm in O(|S|²log|S|) because all edge weights are non-negative.

In another embodiment, program 150 utilizes another criterion for assigning states to meta-states: if state s lies on many of the paths between one meta-state Φᵢ and all other meta-states, then program 150 assigns s to the meta-state Φᵢ, i.e., ϕ(s)=Φᵢ. Program 150 proceeds by defining, for fixed state s and its assigned meta-state Φ(s), the number of shortest paths leaving ϕ(s) that s lies on. In an embodiment, program 150 denotes T(s,s′) as the set of states that lie on the maximum likelihood path between s and s′, i.e., the set of states that define γ(s,s′). Then 1[s∈T(s′,s″)] is the indicator of whether state s lies on the maximum likelihood path between s′ and s″, and program 150 computes the count of the number of such paths for state s and meta-state ϕ(s) via:

$$C ( s , Φ ( s ) ) = {\sum }_{\begin{matrix}{s}^{′} \neq s , \\ Φ ( {s}^{′} ) = Φ ( s )\end{matrix}} {\sum }_{\begin{matrix}{s}^{″} : \\ Φ ( {s}^{″} ) = Φ ( s )\end{matrix}} 1 [ s ∈ T ( {s}^{′} , {s}^{″} ) ] \qquad 1 )$$

with respect to equation (1), C(s,ϕ(s)) can be computed for all s∈S in O(|S|²) by iteratively checking if predecessors of shortest paths from each node to every other node lie in the same meta-state as the first node on the path. In this embodiment, the predecessor matrix was already computed for matrix Γ above. In another embodiment, program 150 also considers to likelihood of out-paths by replacing the indicator in equation (1) with γ(s′,s″).

Program 150 identifies meta-states (step 204). In an embodiment, program 150 identifies a plurality of meta-states that balance the criteria of having high likelihood paths within the meta-state and having many out-paths from states within the meta-state. Program 150 initially computes an eigen representation of each state from eigen decomposition of matrix Γ. In this embodiment, program 150 minimizes the following objective for a suitable representation of s, i.e., the eigen-decomposition of the Laplacian of Γ:

$$\begin{matrix}argmin \\ {s}_{Φ}\end{matrix} = {\sum }_{Φ ∈ {S}_{Φ}} {\sum }_{s ∈ Φ} [ {( s - {c}_{Φ} )}^{2} - η C ( s , Φ ) ] \qquad 2 )$$

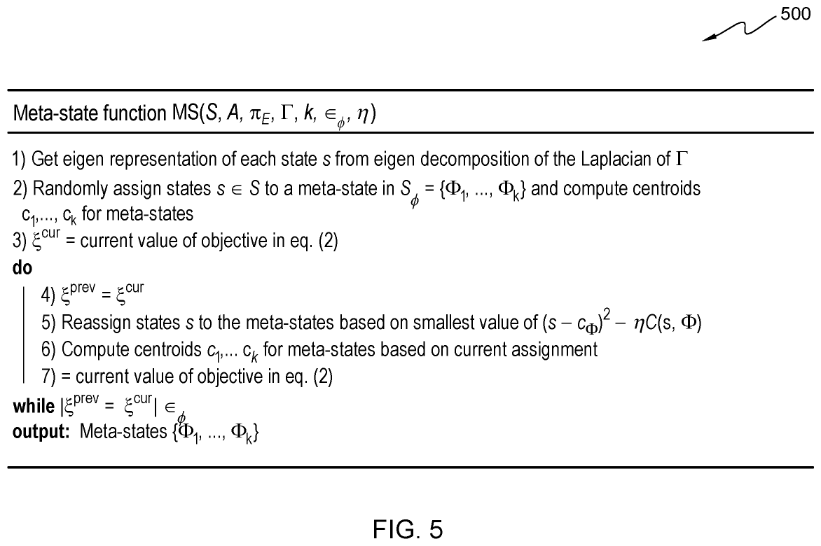

with respect to equation (2), where c_{Φ} denotes the centroid of the meta-state Φ and η>0 balances the trade-off between the criteria. In an embodiment, program 150 randomly assign each state to a meta-state and program 150 computes a centroid for each respective state and meta-state. In an embodiment, program 150 optimizes S_{ϕ} over all possible sets of meta-states, wherein the choice is motivated from the fact that such formulations are nostalgic of spectral clustering which is known to partition by identifying bottlenecks effectively. An embodiment for solving equation (2) is given by the algorithm depicted in FIG. 5 (i.e., algorithm 500) and can be viewed as a regularized version of spectral clustering. In another embodiment, program 150 loops step 204 until convergence following directly due to the present invention's objective being bounded and monotonically decreases at each iteration. Algorithm 500 further describes step 204.

Number of Meta-states k: The number of meta-states can be chosen using standard techniques as trying different k and finding the “knee of the objective” (i.e., where the objective has little improvement) or based on domain knowledge. State representations may affect the (appropriate) number. In an embodiment, the meta-states provide enhanced user comprehension due to incorporation of policy dynamics associated with the deep reinforcement learning policy.

Program 150 identifies strategic states (step 206). Responsive to the convergence described in step 204, program 150 selects one or more strategic states for each meta-state. In an embodiment, program 150 assumes that g₁^{Φ}, . . . , gₘ^{Φ}∈S are m strategic states for a meta-state Φ that does not contain the target state. In this embodiment, program 150 identifies strategic states by solving the following optimization problem for some λ>0:

$${G}_{Φ}^{( m )} = \begin{matrix}argmin \\ {g}_{1}^{Φ} , … , {g}_{m}^{Φ}\end{matrix} {\sum }_{i = 1}^{m} C ( {g}_{i}^{Φ} , Φ ) - λ {\sum }_{i = 1}^{m - 1} {\sum }_{j = i + 1}^{m} max ( γ ( {g}_{i}^{Φ} , {g}_{j}^{Φ} ) , γ ( {g}_{j}^{Φ} , {g}_{i}^{Φ} ) ) \qquad 3 )$$

with respect to equation (3), the first term favors states that lie on many out-paths from the meta-state, while the second term favors states that are far from each other. Thus, the overall objective of program 150 is to identify bottleneck states that go to different highly rewarding parts of the state space from a particular meta-state, while also balancing the selection of bottleneck states to be diverse (i.e., far from each other). Program 150 groups based on policy dynamics and by identifying bottlenecks, i.e., states through which many paths cross. The objective in equation (3) is submodular as embodiments show next and hence program 150 employs a greedy selection in algorithm 3, which finds strategic states for each meta-state. In an embodiment, for the meta-state that contains the target state, the target state itself is its only strategic state. Algorithm 600 further describes step 206. In an embodiment, in order to run program 150 with the exponential state space, embodiments of the present invention use local approximations to the state space (with the maximum number of steps set to 6).

Program 150 presents strategic states explanation (step 208). In an embodiment, program 150 presents the identified meta-states and associated identified strategic states in a visualization focusing strategic states to aid a user or system to clearly understand a RL policy comprised within a visualized grouping or clusters. Here, program 150 generates a visualization of the clustered states by program 150 using algorithm 400 according to the policy dynamics (i.e., maximum likelihood path matrix Γ) resulting in an accurate and reliable clustering of states according to the rooms. FIG. 3C illustrates the difference between explainability and compression when considering meta-states. Here, X's denote strategic states learned in each meta-state, with a larger X corresponding to the first strategic state found. The purpose of this embodiment is to learn abstract states upon which a proxy policy can be learned more efficiently that replicates the original expert policy on the full state space. The lack of interpretability of the abstract states is not of concern in that context. In an embodiment, program 150 utilizes the visualizations explain reasons for a certain action in a particular state. These are primarily contrastive where side information such as access to the causal graph may be assumed. In an embodiment, program 150 utilizes synthesis-type methods that learn syntactical programs representing policies, which although more structured in their form, are typically not amenable to lay users. In an embodiment, program 150 utilizes the identified strategic states to uncover failure points of a policy through generating critical states.

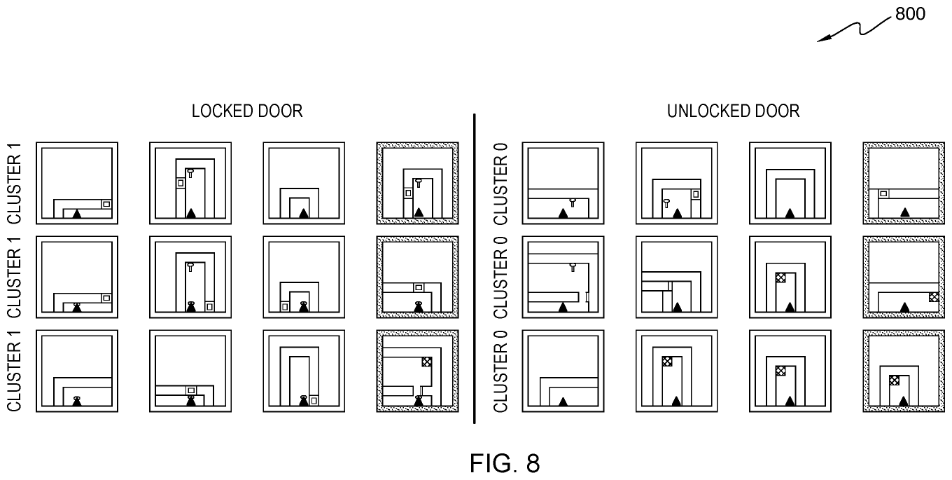

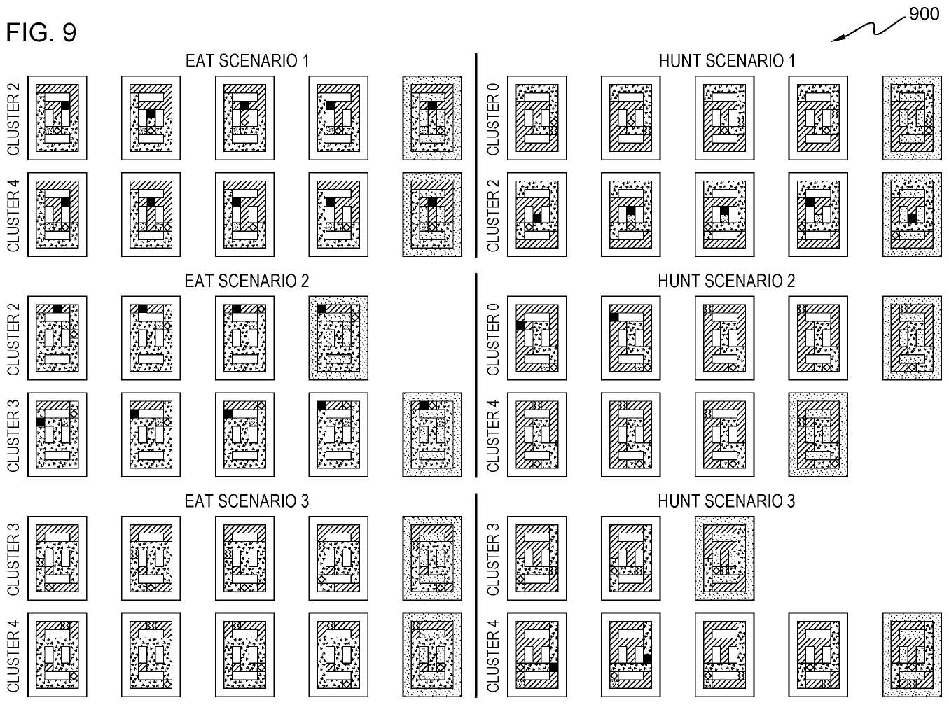

In another embodiment, program 150 generates an explanation containing strategic states and actions according to an associated policy, as depicted by FIGS. 8 and 9. In various embodiments, program 150 constructs a document (e.g., downloadable document, spreadsheet, image, graph, etc.) containing the generated explanations. In this embodiment, the document is a digital or physical document (e.g., printed). In another embodiment, program 150 creates a visual representation the explanations, allowing a user to interact, add, modify, and/or remove one or more states. In yet another embodiment, program 150 presents one or more explanations on a graphical user interface (not depicted) or a web graphical user interface (e.g., generates hypertext markup language contained the generated explanations). Program 150 may output explanations into a plurality of suitable formats such as text files, HTML, files, CSS files, JavaScript files, documents, spreadsheets, etc. In an embodiment, program 150 utilizes the generated explanations to simulate a RL policy to predict behavior (e.g., success or compliance) of the policy.

### FURTHER COMMENTS AND/OR EMBODIMENTS

A large body of work in explainable AI (XAI) has focused on explaining black-box classification models. Explaining deep reinforcement learning (RL) policies in a manner that could be understood by domain users has received much less attention. Embodiments of the present invention propose a novel perspective to understanding RL policies based on identifying strategic states from automatically learned meta-states. The key conceptual difference between the present invention and many previous ones is that the present invention forms meta-states based on locality governed by the expert policy dynamics rather than based on similarity of actions, and that embodiments of the present invention do not assume any particular knowledge of the underlying topology of the state space. Theoretically, embodiments of the present invention show that meta-states converge and the objective to find strategic states for each meta-state is submodular leading to efficient high quality greedy selection. Experiments on three domains (four rooms, door-key, and maze game) and a carefully conducted user study illustrate that the present invention leads to better understanding of the policy. Embodiments of the present invention conjecture that this is a result of the present invention grouping of states to form meta-states being more intuitive in that corresponding strategic states are strong indicators of tractable intermediate goals that are easier for humans to interpret and follow.

Deep reinforcement learning has seen stupendous success over the last decade with superhuman performance in games such as Go and Chess. With increasing superior capabilities of automated (learning) systems, there is a strong push to understand the reasoning behind their decision making. One motivation is for (professional) humans to improve their performance in these games. An even deeper reason is for humans to be able to trust these systems if they are deployed in real life scenarios. Safety, for instance, is of paramount importance in applications such as self-driving cars or deployments on unmanned aerial vehicles (UAVs). Regulations have passed in many countries that require that explanations be provided for any automated decisions that affect humans (e.g., handle personal identifiable information associated with one or more individuals). While various methods with different flavors have been provided to explain classification mode and evaluated in application-grounded manners, the exploration of different perspectives to explain reinforcement learning (RL) policies has been limited and user study evaluations are rarely employed in this space.

Embodiments of the present invention provide a novel perspective to produce human understandable explanations assisting users to predict the behavior of a policy better. Embodiments of the present invention involve abstracting out meta-states based on the dynamics of the policy to be explained followed by identifying strategic states which act as intermediate goals for states belonging to a particular meta-state. These strategic states are essentially bottlenecks in the policy that the present invention identifies without assuming access to the underlying topology. An example of this is seen in FIG. 3A, where (roughly) each room is identified as a meta-state by the present invention with the corresponding doors (bottleneck states) being the strategic states for the meta-state. A key conceptual difference between the present invention compared to other global (and even local) explainable RL approaches is that other approaches aggregate insight (i.e., reduce dimension) as a function of actions, whereas embodiments of the present invention aggregate based on locality of the states determined by the expert policy dynamics and further identify strategic states based on these dynamics. Note that locality is not determined assuming knowledge of the underlying structure or topology of the state space. Embodiments of the present invention show that this perspective leads to more understandable explanations; aggregating based on actions, while precise, are too granular a view where the popular idiom cannot see the forest for the trees comes to mind. Embodiments of the present invention conjecture that the improved understanding is due to grouping of states being more intuitive with strategic states indicating tractable intermediate goals that are easier to follow. An example of this is again seen in FIGS. 3B and 3C, where grouping based on actions for interpretability or for efficiency leads to less intuitive results. A more detailed discussion of this scenario can be found below.

Embodiments of the present invention offer a novel framework for understanding RL policies differs greatly from other methods in this space which create explanations based on similarity of actions rather than policy dynamics. Embodiments of the present invention demonstrate on three domains of increasing difficulty. Embodiments of the present invention conduct a task-oriented user study to evaluate effectiveness. Task-oriented evaluations are one of the most thorough ways of evaluating explanation methods as they assess simulatability of a complex AI model by a human have rarely been used in the RL space.

Embodiments of the present invention use the following notations. Let S define the full state space and s∈S be a state in the full state space. Denote the expert policy by π_{g} (⋅,⋅):(A,S)→ [symbol] where A is the action space. The notation π_{E}∈ [symbol] ^{|A|×|S|} is a matrix where each column is a distribution of actions to take given a state (i.e., the policy is stochastic). Note that embodiments of the present invention assume a transition function f_{E}(⋅,⋅):(S,S)→ [symbol] that defines the likelihood of going from one state to another state in one jump by following the expert policy.

Let S_{ϕ}={Φ₁, . . . , Φₖ} denote a meta-state space of cardinality k and ϕ(⋅):S→S_{ϕ} denote a meta-state mapping such that ϕ(s)∈S_{ϕ} is the meta-state assigned to s∈S. Denote m strategic states of meta-state Φ by G^{Φ}={g₁^{Φ}, . . . , gₘ^{Φ}} where g₁^{Φ}∈S∀∈{1, . . . , m}.

Embodiments of the present invention propose algorithm 400 which involves computing shortest paths between states, identifying meta-states, and selecting their corresponding strategic states. However, embodiments of the present invention first define certain terms. Maximum likelihood (expert) paths: One criterion used below is that two states in the same meta state should not be far away from each other. The distance the present invention considers is the most likely path from state s to state s′ under π_{E}. Consider a fully connected, directed (in both directions) graph where the states are vertices and an edge from s to s′ has weight −log f_{E}(s,s′). By this definition, the shortest path is also the maximum likelihood path from s to s′. Denote by γ(s,s′) the value of this maximum likelihood path and Γ∈ [symbol] ^{|S|×|S|} a matrix containing the values of these paths for all pairs of states in the state space. Γ, along with a predecessor matrix P that can be used to derive the shortest paths, can be computed using Dijkstra's shortest path algorithm in O(|S|²log|S|) because all edge weights are non-negative. Below discusses how the algorithm is applied with a large state space (using local state space approximations).

Another criterion used below for assigning states to meta-states is that if state s lies on many of the paths between one meta-state Φᵢ and all other meta-states, then s should be assigned the meta-state Φᵢ, i.e., Φ(s)=Φᵢ. Embodiments of the present invention proceed by defining, for fixed state s and its assigned meta-state ϕ(s), the number of shortest paths leaving ϕ(s) that s lies on. Denote T(s,s′) as the set of states that lie on the maximum likelihood path between s and s′, i.e., the set of states that define γ(s,s′). Then 1[s∈T(s′,s″)] is the indicator of whether state s lies on the maximum likelihood path between s′ and s″, and embodiments compute the count of the number of such paths for state s and meta-state ϕ(s) via:

$$C ( s , Φ ( s ) ) = {\sum }_{\begin{matrix}{s}^{′} \neq s , \\ Φ ( {s}^{′} ) = Φ ( s )\end{matrix}} {\sum }_{\begin{matrix}{s}^{″} : \\ Φ ( {s}^{″} ) = Φ ( s )\end{matrix}} 1 [ s ∈ T ( {s}^{′} , {s}^{″} ) ] \qquad 1 )$$

with respect to equation (1), C(s,ϕ(s)) can be computed for all s∈S in O(|S|²) by iteratively checking if predecessors of shortest paths from each node to every other node lie in the same meta-state as the first node on the path. Note this predecessor matrix was already computed for matrix Γ above. One may also consider to likelihood of out-paths by replacing the indicator in equation (1) with γ(s′,s″).

Embodiments of the present invention seek to learn meta-states that balance the criteria of having high likelihood paths within the meta-state and having many out-paths from states within the meta-state. This is accomplished by minimizing the following objective for a suitable representation of s, which in the case of the present invention is the eigen-decomposition of the Laplacian of Γ:

$$\begin{matrix}argmin \\ {s}_{Φ}\end{matrix} = {\sum }_{Φ ∈ {S}_{Φ}} {\sum }_{s ∈ Φ} [ {( s - {c}_{Φ} )}^{2} - η C ( s , Φ ) ] \qquad 2 )$$

with respect to equation (2), where c_{Φ} denotes the centroid of the meta-state Φ and η>0 balances the trade-off between the criteria. Note that embodiments of the present invention are optimizing S_{ϕ} over all possible sets of meta-states. Other representations for s and functions for the first term could be used, but, here, the choice is motivated from the fact that such formulations are nostalgic of spectral clustering which is known to partition by identifying bottlenecks effectively, something embodiments of the present invention strongly desire. The present invention's method for solving equation (2) is given by the algorithm depicted in FIG. 5 (i.e., algorithm 500) and can be viewed as a regularized version of spectral clustering. The below convergence follows directly since the present invention's objective is bounded and monotonically decreases at each iteration.

Proposition 1: Meta-state finding Algorithm 500 converges.

Next, strategic states must be selected for each meta-state. Assume that g₁^{Φ}, . . . , gₘ^{Φ}∈S are m strategic states for a meta-state Φ that does not contain the target state. Embodiments of the present invention find strategic states by solving the following optimization problem for some λ>0:

$${G}_{Φ}^{( m )} = \begin{matrix}argmin \\ {g}_{1}^{Φ} , … , {g}_{m}^{Φ}\end{matrix} {\sum }_{i = 1}^{m} C ( {g}_{i}^{Φ} , Φ ) - λ {\sum }_{i = 1}^{m - 1} {\sum }_{j = i + 1}^{m} max ( γ ( {g}_{i}^{Φ} , {g}_{j}^{Φ} ) , γ ( {g}_{j}^{Φ} , {g}_{i}^{Φ} ) ) \qquad 3 )$$

with respect to equation (3), the first term favors states that lie on many out-paths from the meta-state, while the second term favors states that are far from each other. Thus, the overall objective tries to pick bottleneck states that go to different highly rewarding parts of the state space from a particular meta-state, while also balancing the selection of bottleneck states to be diverse (i.e., far from each other). The objective in equation (3) is submodular as embodiments show next and hence embodiments of the present invention employ greedy selection in algorithm 3, which finds strategic states for each meta-state. Note that for the meta-state that contains the target state, the target state itself is its only strategic state.

Proposition 2: The objective to find strategic states in equation 3 is submodular.

Strategic State eXplanation (SSX) method: an embodiment method is detailed in algorithm 1. First, the maximum likelihood path matrix Γ is computed. Then, the algorithm tries to find meta-states that are coherent with regard to the expert policy, in the sense that embodiments group states into a meta-state if there is a high likelihood path between them. Additionally, if many paths from states in a meta-state go through another state, then the state is biased to belong to this meta-state. Finally, strategic states are selected by optimizing a trade-off between being a bottleneck with having a diverse set of strategic states.

Given the general method of the present invention, the embodiments below explain certain details that were important for making the present invention practical when applied to different domains.

Storing Paths: The predecessor matrix P is defined such that P_{i,j} is the predecessor of state j on a shortest path from i to j (and infinity if no such path exists). This matrix is used to retrieve the shortest path between any two states i to j. Then a strategic state is defined as a state s′ such that Pₛₜ=s′ where ϕ(s)=ϕ)(s′)≠ϕ(t), i.e., s′ is the last node on the shortest path between states s and t that are in two different meta-states that lies in the same meta-state as s. Then, by this definition, embodiments can penalize the number of strategic states.

Scalability: SSX is applied above to games with state spaces ranging from small to exponential in size. Algorithm 400 is straight forward for small state spaces as one can pass the full state space as input, however, neither finding meta-states nor strategic states would be tractable with an exponential state space. One approach could be to compress the state space using VAEs, but as shown in FIG. 3C, interpretability of the state space can be lost as there is little control as to how states are grouped. The same phenomenon can be observed when considering compression versus explainability in other contexts such as classification models. Embodiments of the present invention use local approximations to the state space; given a starting position, SSX approximates the states space by the set of states within some N>0 number of moves from the starting position. Considering different starting positions will offer the user a global explanation for a fixed policy. In this approach, Algorithms 500 and 600 are a function of N, i.e., increasing N increases the size of the approximate state space which is passed to both algorithms. One can contrast the present invention of locally approximating the state space with that of VIPER which uses full sample paths to train decision trees.

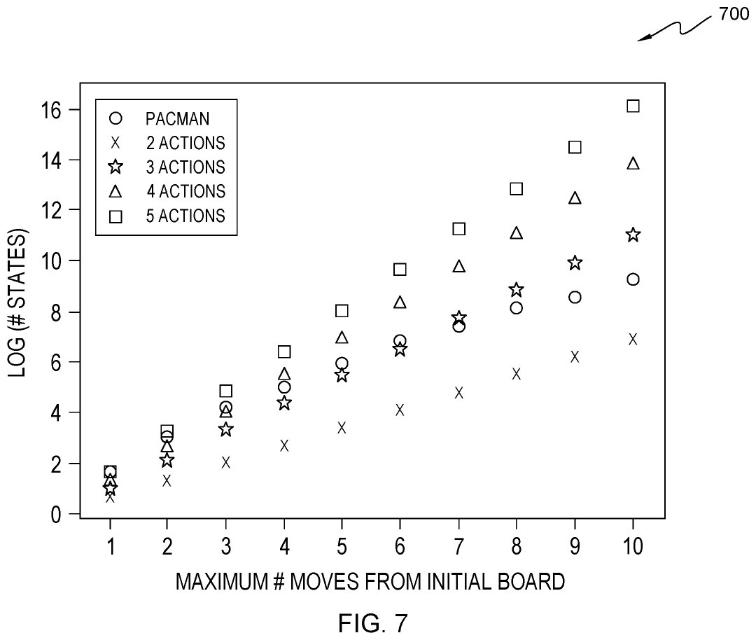

FIG. 7 displays how the state space size in maze game, discussed below, grows as the number of possible moves N allowed for the local approximation grows. Worst case state space size for local approximations is N^{M} where M is the number of possible actions per move. At any position on the board, maze game has at most 4 possible actions (3 possible directions to move or stay) and the adversary has an additional 3 potential actions for a total of 7 possible state movements at most. The state space of maze game is averaged over 100 random samples for each N=1, . . . , 10 and, while growing exponentially, acts similar to a game with between 2-3 actions per move because most states in the local approximation are duplicates due to both maze game and the adversary going back and forth. When enumerating the local state space, duplicates can be removed before looking another move into the future so that the local state space stored does not grow at the maximum rate in practice. Also note that the size of the local approximation to the state space will not be affected if the board size increases because only local states are considered.

Number of Meta-states k: The number of meta-states can be chosen using standard techniques as trying different k and finding the knee of the objective (i.e., where the objective has little improvement) or based on domain knowledge. State representations may affect the (appropriate) number.

While a plethora of methods are proposed in XAI, embodiments of the present invention focus on works related to RL explainability and state abstraction, as they are most relevant. Some works try to learn self-explaining models where the policy has soft attention and so can indicate which (local) factors it is basing its decision on at different points in the state space. This is more of a local direct interpretation method rather than a (global) post hoc method and hence different from the approach suggested in the present invention. Interestingly, there are works which suggest that attention mechanisms should not be considered as explanations.

Other works use local explanation methods to explain reasons for a certain action in a particular state. These are primarily contrastive where side information such as access to the causal graph may be assumed. Further, other works try to find state abstractions or simplify the policy, but more so with the intent of efficient learning rather than interpretability. Methods such as can globally interpret a policy, where although the exact objective function may be different, they all try to explain by using state variables to group actions. Embodiments of the present invention, as mentioned before, besides being methodologically different, also differs conceptually from these, where the present invention groups based on policy dynamics and by identifying bottlenecks, i.e., states through which many paths cross.

There are also program synthesis-type methods that learn syntactical programs representing policies, which although more structured in their form, are typically not amenable to lay users. There are also methods in safe RL that try to uncover failure points of a policy by generating critical states, which is of course different than the goal of the present invention.

This section illustrates the Strategic State eXplanation (SSX) method on three different domains: four rooms, door-key, and maze game. These domains represent different reinforcement learning (RL) regimes, namely, 1) non-adversarial RL with a small state space and tabular representation for the policy, 2) non-adversarial RL with a large state space and a deep neural network for the policy, and 3) adversarial RL with a large state space and a deep neural network for the policy. These examples exemplify how strategic states can aid in understanding RL policies. All experiments described were performed with 1 GPU and up to 16 GB RAM. The number of strategic states was chosen such that an additional strategic state resulted in at least a 10% increase in objective. The number of meta-states was selected as would be done in practice, through cross-validation to satisfy human understanding.

Four Rooms: The Four Rooms game is displayed in FIGS. 3A, 3B, and 3C. The objective is to get from the initial state (lower left corner) to the goal state (upper right corner). A player can move left, right, up, or down. Players can only move to a position that has a color marker. The lack of a marker in a position represents a wall. The setup in this experiment is an 11 by 11 grid. The state space consists of the current position of a player and the policy is learned as a tabular representation, since the state space is not too large, using Value Iteration.

SSX is displayed in FIG. 3A with settings that learn four meta-states and up to two strategic states per meta-state. Clustering the states using algorithm 400 according to the policy dynamics (i.e., maximum likelihood path matrix Γ) results in an (almost) perfect clustering of states according to the rooms. X's denote strategic states learned in each meta-state, with a larger X corresponding to the first strategic state found. Clearly either door in blue, green, or red rooms could lead to the goal state in the upper right corner (large yellow diamond), but it is important to note that higher valued strategic states in the red and blue rooms are those that lead directly to the yellow room where the goal state is located.

FIG. 3B illustrates the results of VIPER-D which is the present invention's adaptation of VIPER for discrete state spaces. In this case embodiments of the present invention apply VIPER-D to the entire state space as sampling of paths is not required given that the state space is not too large. The explanation is illustrated using different colors per action which effectively offers the rules of the entire decision tree. While an explanation based on rules can be informative in continuous state spaces, such rules applied to a discrete state space as done here may lead to confusion, e.g., there are red states in different patterns split up by the yellow states in the two rooms on the left and it is not clear how to describe the cluster of states in which to take each action. As is demonstrated via a user study on the maze game, the visualization of strategic states is clearly more understandable to a user than this form of grouping. FIG. 3C is meant to illustrate the difference between explainability and compression when considering meta-states. The purpose of the above is to learn abstract states upon which a proxy policy can be learned more efficiently that replicates the original expert policy on the full state space. The lack of interpretability of the abstract states is not of concern in that context.

Door-Key: Door-Key is another non-adversarial game, but what differs from Four Rooms is that the state space is exponential in the size of the board. The policy is learned as a convolutional neural network (CNN) with three convolutional and two linear layers using the Door-Key environment (i.e., minimalistic gridworld). In this game, one must navigate from one room through a door to the next room and find the goal location to get a reward. Policies are trained under two scenarios. In the first scenario, there is a key in the first room that must be picked up and used to unlock the door before passing through. In the second scenario, the door is still closed but unlocked, so one does not need to first pick up the key to pass through.

In order to run SSX with the exponential state space, embodiments of the present invention use local approximations to the state space (with the maximum number of steps set to 6) as discussed above. Results are shown in FIG. 8. The state space is a 7 by 7 grid reflecting the forward-facing perspective of the agent. Walls are light gray and empty space that the agent sees are dark gray. Grid positions blocked from view by walls are black. Explainability provided by SSX is used to distinguish between the locked and unlocked door policies; given a sample path to solve each task, SSX was run at different states along the path, three of which are shown for each environment with one meta-state and corresponding strategic state (outlined in pink) displayed. The three strategic states for the locked door environment correspond to the agent looking for the key (row 1), getting the key (row 2), and using it to open the door (row 3). The three strategic states for the unlocked door environment correspond to the agent immediately looking for the door (row 1), going through the door (row 2), and moving toward the target (row 3).

Maze game: This game differs from Door-Key with the addition of an adversary. The state space is again exponential in the size of the board and the policy is learned as a convolutional neural network with two convolutional and two linear layers on a modified environment. Two policies are trained with two different objectives. The first objective, denoted EAT, is for maze game to eat all the food. There is no reward for eating the adversary. The second objective, denoted HUNT, is for maze game to hunt the adversary. There is no reward for eating food.

SSX is again run with local approximations to the state space with the maximum number of steps set to 8. The state space is a 10 by 7 grid reflecting where food, player, an adversary, and the pill are located. FIG. 9 displays three sample scenarios under both the EAT and HUNT policies, with two meta-states and corresponding strategic states highlighted in pink per scenario. The two strategic states of EAT Scenario 1 show player eating the food (Cluster 4) but then avoiding the adversary and ignoring the pill (Cluster 2). EAT Scenario 2 shows player willing to take a chance of being eaten in order to get more food and EAT Scenario 3 shows that, even though player already ate the pill (the 268 adversary is yellow when the pill is eaten), player prefers to eat more food rather than head for the adversary. These strategic states contrast directly with those in the HUNT scenarios. In HUNT Scenario 1, player is either directly moving towards the adversary after having eaten the pill (Cluster 0) or heading away from the pill while the adversary is near it (Cluster 2). Strategic states in Hunt Scenarios 2 and 3 also show player eating the pill in order to hunt the adversary rather than eating more food.

The present invention illustrates a user study to evaluate the utility of this approach relative to the more standard approach of explaining based on grouping actions. As with Four Rooms, embodiments of the present invention again compare with this implementation of VIPER—a state-of-the-art explanation method for reinforcement learning policies—adapted to discrete state spaces called Viper-D. The utility of each approach is measured through a task posed to study participants: users must guess the intent of the expert policy based on provided explanations which are either output by SSX or Viper-D.

Setup: The present invention uses the maze game framework with the EAT and trained HUNT policies and each question shows either an SSX explanation or Viper-D explanation and asks the user “Which method is the explanation of type A (or B) explaining?” to which they must select from the choices Hunt, Eat, or Unclear. Methods are anonymized (as A or B) and questions for each explanation type are randomized. Ten questions (five from both the EAT and HUNT policies) are asked for each explanation type giving a total of twenty questions to each participant. In addition, at the end of the study, the users are asked to rate each explanation type based on a 5-point Likert scale for four qualitative metrics—completeness, sufficiency, satisfaction, and understandability. For users to familiarize themselves with the two types of explanations the users were also provided with two training examples one for each type at the start of the survey.

To be fair to VIPER-D explanations, rather than just displaying rules in text which may not be aesthetically pleasing, there also was a created visualization which not only displayed the (five) rules to the user, but also three boards, one each for player, the adversary, and the pill, highlighting their possible locations as output by the rule.

The study has 37 responses from people with quantitative/technical backgrounds, but not necessarily AI experts. 5 responses were removed as they were likely due to users pressing the submit button multiple times as we twice received multiple answers within 30 seconds that were identical.

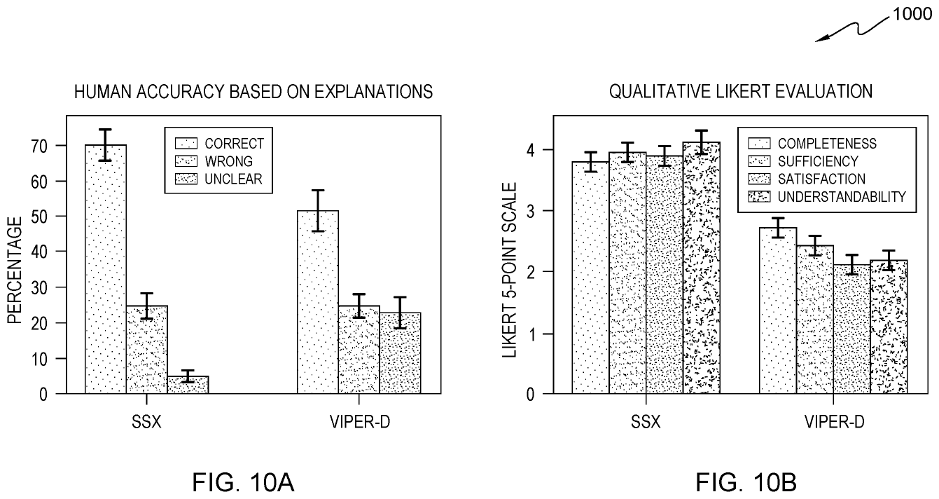

Observations: FIG. 10A displays user accuracy on the task for method SSX and Viper-D. Users clearly were able to better distinguish between the EAT and HUNT policies given explanations from SSX rather than Viper-D and the difference in percentage correct is statistically significant (paired t-test p-value is 0.01). Another interesting note is that less than 5% of SSX explanations were found to be Unclear whereas more than 25% of Viper-D explanations were labeled Unclear, meaning that, right or wrong, users felt more comfortable that they could extract information from SSX explanations.

FIG. 10B displays the results of the qualitative questions (“Was it complete/sufficient/satisfactory/easy to understand?”) for both SSX and Viper-D which users' rate on a 5-point scale ranging from “Not at all” to “Yes absolutely”. All metrics score high for SSX and differences with Viper-D are statistically significant. These results are consistent with the vastly different percentage of Unclear selections for SSX and Viper-D, i.e., users found very few SSX explanations to be unclear and therefore also scored SSX higher in the qualitative metrics.

The present invention demonstrates that this novel approach of identifying strategic states leads to more complete, satisfying, and understandable explanations, while also conveying enough information needed to perform well on a task. Moreover, it applies to single agent as well as multi-agent adversarial games with large state spaces.

Further insight could be distilled from strategic states by taking the difference between the variables in some particular state and the corresponding strategic state and conveying cumulative actions an agent should take to reach those strategic states (viz. go 2 steps up and 3 steps right to reach a door in Four Rooms). This would cover some information conveyed by the typical action-based explanations we have seen while possibly enjoying benefits of both perspectives.

FIGS. 3A, 3B, and 3C depict example 300, in accordance with an illustrative embodiment of the present invention. Example 300 comprises illustrations of program 150 (SSX) (i.e., FIG. 3A), VIPER-D (i.e., FIG. 3B), and abstract states used for compression (i.e., FIG. 3C) methods based on an expert policy for the Four Rooms game with neither having information about the underlying topology of the state space. The hashing denotes the different meta-states or clusters formed by the three methods. The diamond in the upper right is the goal state. Program 150 clusters the four rooms exactly with strategic states denoted by X's, where a bigger X implies the first (or more important) strategic state. As can be seen the present invention's explanation that the expert policy will head towards the open doors in each room preferring the door that leads to the room with the goal state. VIPER-D uses decision trees and clusters states by action based on the full (discrete) state space rather than samples as the original VIPER, since it is tractable in this case. The abstract states method represents a compressed state space on which a policy can perform similarly to the expert policy trained on the original state space, and which also groups states as a function of the experts (conditional) action distribution. FIGS. 3B and 3C demonstrates that the states forming the clusters are scattered enabling no simple description making it potentially more challenging for a human to understand the policy.

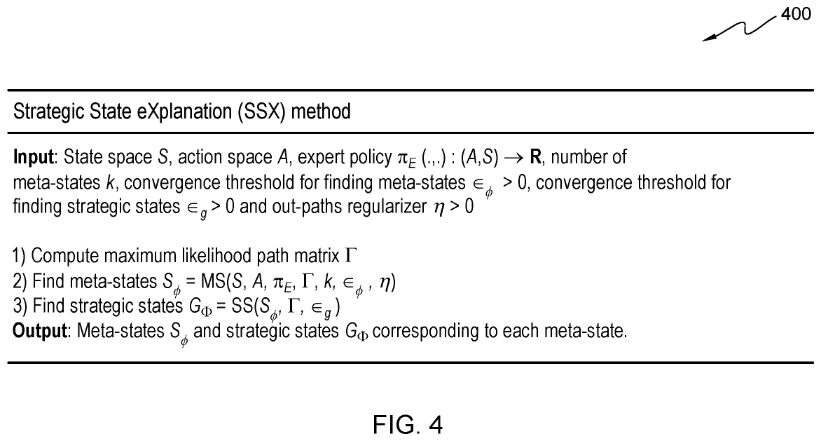

FIG. 4 depicts algorithm 400, in accordance with an illustrative embodiment of the present invention. Algorithm 400 illustrates operational steps of program 150 (SSX) within flowchart 200.

FIG. 5 depicts algorithm 500, in accordance with an illustrative embodiment of the present invention. Algorithm 500 illustrates operational steps of program 150 within step 204 of flowchart 200.

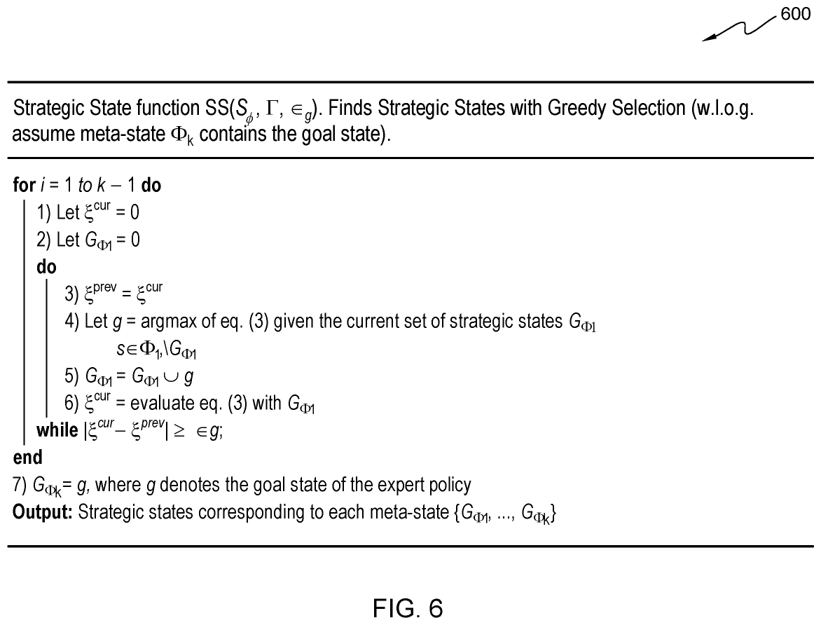

FIG. 6 depicts algorithm 600, in accordance with an illustrative embodiment of the present invention. Algorithm 600 illustrates operational steps of program 150 within step 206 of flowchart 200, i.e., identifying strategic states with greedy selection.

FIG. 7 depicts chart 700, in accordance with an illustrative embodiment of the present invention. Chart 700 illustrates results of program 150 with a state space size in maze game. Worst case state space size for local approximations is N^{M} where N is the maximum number of moves made and M is the number of possible actions per move. Player's state space is averaged over 100 random samples for each N=1, . . . , 10. The state space of maze game, while also growing exponentially, grows much slower (like a game with 2-3 actions per move) which makes program 150 a practical method for such games.

FIG. 8 depicts door-key 800, in accordance with an illustrative embodiment of the present invention. Door-key 800 depicts explanations generated by program 150 on Door-Key. Policies were trained are on two different environments: Locked Door and Unlocked Door. Each row corresponds to a meta-state and strategic state (outlined in a hash pattern) from running program 150 starting at a different number of moves into the same path (one path for completing the task in each of the two environments). For the Locked Door environment, the agent looks for the key (row 1), then gets the key (row 2), then uses it to open the door (row 3). For the Unlocked Door environment, the agent looks for the door (row 1), opens and goes through the door (row 2), and proceeds to the goal state in row 3.

FIG. 9 depicts maze game 900, in accordance with an illustrative embodiment of the present invention. Maze game 900 depicts explanations generated by program 150 on maze game. Two policies, EAT and HUNT, are displayed across three scenarios each. For each scenario, two clusters are shown as part of program 150's result. For a given cluster, the last board with pink background is a strategic state for that cluster. The color scheme is as follows: square hash=player, null hash=adversary, zigzag hash=edible adversary, dot hash =pill, diagonal line hash=food, v hash=food eaten, white hash=wall. In EAT scenarios, player generally ignores the pill and stays away from the adversary (even if the pill has been eaten). In HUNT, player generally looks for the pill (but stays away if the adversary is near it) and moves toward the adversary (if the pill has been eaten).

FIGS. 10A and 10B depicts charts 1000, in accordance with an illustrative embodiment of the present invention. Charts 1000 comprise charts depicting human accuracy on explanations (FIG. 10A) and qualitive Likert evaluation (FIG. 10B). FIG. 10A demonstrates the percentage (human) accuracy in predicting if the expert policy is Eat or Hunt based on program 150 and Viper-D. As can be seen users perform much better with program 150 with difference in performance being statistically significant (paired t-test p-value=0.01). FIG. 10B demonstrates a 5-point Likert scale (higher better) for four qualitative metrics used in previous studies. Here too the difference is statistically significant for all four metrics (p-values for completeness, sufficiency, satisfaction, and understandability are all less than 2×10⁻⁵). Error bars are 1 std error.

FIG. 11 depicts block diagram 1100 illustrating components of server computer 120 in accordance with an illustrative embodiment of the present invention. It should be appreciated that FIG. 11 provides only an illustration of one implementation and does not imply any limitations with regard to the environments in which different embodiments may be implemented. Many modifications to the depicted environment may be made.

Server computer 120 each include communications fabric 1104, which provides communications between cache 1103, memory 1102, persistent storage 1105, communications unit 1107, and input/output (I/O) interface(s) 1106. Communications fabric 1104 can be implemented with any architecture designed for passing data and/or control information between processors (such as microprocessors, communications, and network processors, etc.), system memory, peripheral devices, and any other hardware components within a system. For example, communications fabric 1104 can be implemented with one or more buses or a crossbar switch.

Memory 1102 and persistent storage 1105 are computer readable storage media. In this embodiment, memory 1102 includes random access memory (RAM). In general, memory 1102 can include any suitable volatile or non-volatile computer readable storage media. Cache 1103 is a fast memory that enhances the performance of computer processor(s) 1101 by holding recently accessed data, and data near accessed data, from memory 1102.

Program 150 may be stored in persistent storage 1105 and in memory 1102 for execution by one or more of the respective computer processor(s) 1101 via cache 1103. In an embodiment, persistent storage 1105 includes a magnetic hard disk drive. Alternatively, or in addition to a magnetic hard disk drive, persistent storage 1105 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 1105 may also be removable. For example, a removable hard drive may be used for persistent storage 1105. Other examples include optical and magnetic disks, thumb drives, and smart cards that are inserted into a drive for transfer onto another computer readable storage medium that is also part of persistent storage 1105. Software and data 1112 can be stored in persistent storage 1105 for access and/or execution by one or more of the respective processors 1101 via cache 1103.

Communications unit 1107, in these examples, provides for communications with other data processing systems or devices. In these examples, communications unit 1107 includes one or more network interface cards. Communications unit 1107 may provide communications through the use of either or both physical and wireless communications links. Program 150 may be downloaded to persistent storage 1105 through communications unit 1107.

I/O interface(s) 1106 allows for input and output of data with other devices that may be connected to server computer 120. For example, I/O interface(s) 1106 may provide a connection to external device(s) 1108, such as a keyboard, a keypad, a touch screen, and/or some other suitable input device. External devices 1108 can also include portable computer readable storage media such as, for example, thumb drives, portable optical or magnetic disks, and memory cards. Software and data used to practice embodiments of the present invention, e.g., program 150, can be stored on such portable computer readable storage media and can be loaded onto persistent storage 1105 via I/O interface(s) 1106. I/O interface(s) 1106 also connect to a display 1109.

Display 1109 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, conventional procedural programming languages, such as the “C” programming language or similar programming languages, and quantum programming languages such as the “Q” programming language, Q#, quantum computation language (QCL) or similar programming languages, low-level programming languages, such as the assembly language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
computing, by one or more computer processors, a maximum likelihood path matrix comprising a respective shortest path between each state in a set of states associated with a model trained with a deep reinforcement learning policy; and
generating, by one or more computer processors, explanations for the deep reinforcement learning policy based one or more identified meta-states for each state in the set of states and corresponding selected strategic states utilizing the computed maximum likelihood path matrix.

2. The computer-implemented method of claim 1, wherein identifying the one or more meta-states for each state in the set of states, comprises:
computing, by one or more computer processors, an eigen representation of each state from eigen decomposition of matrix;
randomly assigning, by one or more computer processors, each state to a meta-state; and
computing, by one or more computer processors, a centroid for each assigned state and meta-state.

3. The computer-implemented method of claim 2, further comprising:
optimizing, by one or more computer processors, the one or more identified meta-states until convergence.

4. The computer-implemented method of claim 1, wherein the strategic states are identified by aggregation based on locality of the states determined by reinforcement learning policy dynamics.

5. The computer-implemented method of claim 1, wherein selecting one or more identified strategic states for each identified meta-state employs a greedy selection algorithm.

6. The computer-implemented method of claim 1, further comprising:
identifying, by one or more computer processors, one or more bottleneck states that go to different highly rewarding parts of a state space from a particular meta-state while balancing a selection of bottleneck states to be diverse.

7. The computer-implemented method of claim 1, further comprising:
generating, by one or more computer processors, a visualization of the identified meta-states and strategic states according to deep reinforcement learning policy dynamics.

8. A computer program product comprising:
one or more computer readable storage media and program instructions stored on the one or more computer readable storage media, the stored program instructions comprising:
program instructions to compute a maximum likelihood path matrix comprising a respective shortest path between each state in a set of states associated with a model trained with a deep reinforcement learning policy; and
program instructions to generate explanations for the deep reinforcement learning policy based one or more identified meta-states for each state in the set of states and corresponding selected strategic states utilizing the computed maximum likelihood path matrix.

9. The computer program product of claim 8, wherein the program instructions to identify the one or more meta-states for each state in the set of states, comprise:
program instructions to compute an eigen representation of each state from eigen decomposition of matrix;
program instructions to randomly assign each state to a meta-state; and
program instructions to compute a centroid for each assigned state and meta-state.

10. The computer program product of claim 8, wherein the program instructions, stored on the one or more computer readable storage media, further comprise:
program instructions to optimize the one or more identified meta-states until convergence.

11. The computer program product of claim 8, wherein the strategic states are identified by aggregation based on locality of the states determined by reinforcement learning policy dynamics.

12. The computer program product of claim 8, wherein program instructions to select one or more identified strategic states for each identified meta-state employs a greedy selection algorithm.

13. The computer program product of claim 8, wherein the program instructions, stored on the one or more computer readable storage media, further comprise:
program instructions to identify one or more bottleneck states that go to different highly rewarding parts of a state space from a particular meta-state while balancing a selection of bottleneck states to be diverse.

14. The computer program product of claim 8, wherein the program instructions, stored on the one or more computer readable storage media, further comprise:
program instructions to generate a visualization of the identified meta-states and strategic states according to deep reinforcement learning policy dynamics.

15. A computer system comprising:
one or more computer processors;
one or more computer readable storage media; and
program instructions stored on the computer readable storage media for execution by at least one of the one or more processors, the stored program instructions comprising:
program instructions to compute a maximum likelihood path matrix comprising a respective shortest path between each state in a set of states associated with a model trained with a deep reinforcement learning policy; and
program instructions to generate explanations for the deep reinforcement learning policy based one or more identified meta-states for each state in the set of states and corresponding selected strategic states utilizing the computed maximum likelihood path matrix.

16. The computer system of claim 15, wherein the program instructions to identify the one or more meta-states for each state in the set of states, comprise:
program instructions to compute an eigen representation of each state from eigen decomposition of matrix;
program instructions to randomly assign each state to a meta-state; and
program instructions to compute a centroid for each assigned state and meta-state.

17. The computer system of claim 15, wherein the program instructions, stored on the one or more computer readable storage media, further comprise:
program instructions to optimize the one or more identified meta-states until convergence.

18. The computer system of claim 15, wherein the strategic states are identified by aggregation based on locality of the states determined by reinforcement learning policy dynamics.

19. The computer system of claim 15, wherein program instructions to select one or more identified strategic states for each identified meta-state employs a greedy selection algorithm.

20. The computer system of claim 15, wherein the program instructions, stored on the one or more computer readable storage media, further comprise:
program instructions to identify one or more bottleneck states that go to different highly rewarding parts of a state space from a particular meta-state while balancing a selection of bottleneck states to be diverse.
